(19) United States
(12) Patent Application Publication
(10) Pub. No.: US 2010/0314450 A1
(43) Pub. Date: Dec. 16, 2010

(54) DOCUMENT AUTHENTICATION

(76) Inventor: Timothy Jason Powell, Aurora, IN (US)

Correspondence Address: FISH & RICHARDSON P.C. (NY), P.O. BOX 1022, MINNEAPOLIS, MN, 55440-1022, US

(21) Appl. No.: 12/691,906

(22) Filed: Jan. 22, 2010

Related U.S. Application Data
(60) Provisional application No. 61/187,513, filed on Jun. 16, 2009.

(51) Int. Cl. G06K 19/06; G06F 17/30

(52) U.S. Cl. 235/491; 235/494; 707/802; 707/E17.044

(57) ABSTRACT

A computer-based method includes providing multiple substantially similar documents, generating a series of unique identification codes and printing an identification marking that corresponds to one of the identification codes for each of the documents. Each of the printed identification markings includes at least a first portion printed with a first ink to produce a first visual effect and a second portion printed with a second ink that produces a second visual effect different than the first visual effect.

### CROSS-REFERENCE TO RELATED APPLICATION

This application claims the benefit of and priority to U.S. Provisional Application No. 61/187,513, filed Jun. 16, 2009, the disclosure of which is hereby incorporated by reference in its entirety.

### FIELD OF THE INVENTION

This specification relates to document authentication and, more particularly, to applying markings to documents that facilitate authentication and deter counterfeiting.

### BACKGROUND

Counterfeiting generally refers to the imitation of money, documents, products, etc. with the intent to deceptively represent its content, value or origin. Forgery can be considered a type of counterfeiting that includes making, adapting, or imitating objects, statistics, or documents, with the intent to deceive.

A number of measures have been developed and implemented to attempt to combat counterfeiting and other deceptive practices that might harm legitimate businesses and the public at large.

Counterfeiters generally try to imitate product authentication measures. Successful imitation can reduce the effectiveness of those measures.

### SUMMARY OF THE INVENTION

This specification relates to document authentication and, more particularly, to applying markings to documents that facilitate authentication and deter counterfeiting.

The markings can be used as a security feature to authenticate or deter illegal reproduction of security documents. The markings include variable information (i.e., information that varies from one document to the next). The variable information can be in the form of a barcode, number, image, alphanumeric code, any form of serialization, code, etc. The variable information is split vertically, horizontally or diagonally into sections, with adjacent sections having different appearances (e.g., different colors, internal patterns, etc.).

In one aspect, a computer-based method includes providing a plurality of substantially similar documents, generating a series of unique identification codes, and printing an identification marking that corresponds to one of the identification codes for each of the documents. Each of the printed identification markings has at least: a first portion printed with a first ink to produce a first visual effect (e.g., a first color); and a second portion printed with a second ink that produces a second visual effect (e.g., a second color) different than the first visual effect.

In some embodiments, the series of unique identification codes is generated by a computer processor and the identification markings are printed by an electronic printer coupled to the computer processor.

Certain implementations include associating each of the unique identification markings with one of the documents.

In some exemplary embodiments, the first portion of each printed identification marking is an upper portion the identification marking and the second portion of each printed identification marking is a lower portion of the identification marking. In some exemplary implementations, the first portion of each printed identification marking is a left portion of the identification marking and the second portion of each printed identification marking is a right portion of the identification marking.

According to some implementations, the printed identification marking has a plurality of discrete characters. In these instances, the first portion of each identification code transitions into the second portion of each identification code within at least one, but sometimes more than one, of the characters.

In a typical implementation, the computer-based method includes storing each unique identification code in an electronic database. Moreover, in some embodiments, a logical association is created in the electronic database between each stored identification code and one of the documents upon which a corresponding one of the identification markings is printed or affixed.

In some implementations, the first portion of each identification marking or the second portion of each identification marking is substantially invisible to the human eye absent exposure to an environmental condition (e.g., an ultraviolet or infrared light source, a source of heat or a chemical). In these implementations, the first portion of each identification marking and the second portion of each identification marking can be substantially invisible to the human eye absent exposure to the environmental condition.

Each identification marking can be printed in such a manner that, upon exposure to the environmental condition, the first portion of the identification marking and the second portion appear as different colors.

In some embodiments, each identification marking is printed using fluorescent ink such that, upon exposure to an ultraviolet or infrared light source as the environmental condition, the first portion of each identification marking or the second portion of each identification marking glows.

The substantially similar documents can be one of the following types of documents: identification cards, currency, credit cards, stored value cards, stock certificates, vital records, certificates of origin, labels, tapes, gift certificates, checks, passports, titles, coupons, or forms of commercial paper.

According to certain implementations, each identification marking is printed on an associated adhesive label and secured to an associated one of the documents.

In some embodiments, each identification marking includes an alphabetic code, a numeric code, an alphanumeric code, a symbolic code, a barcode, an image code or a bitmap code.

The unique identification codes typically are logically-related to one another (e.g., sequentially or related to one another by some logical function). However, they also can be random relative to one another.

In some instances, the identification marking has a transition area between the first portion of the marking and the second portion of the marking that presents a gradual blending of one color into another color. The transition area can include printed dots of the first ink (or first color) interspersed among printed dots of the second ink (or second color). In some embodiments, the printed dots and/or visual details of the transition area are only visible under magnification.

In another aspect, a system for facilitating document tracking and authentication includes multiple substantially identical documents and a unique identification marking on each document, each identification marking corresponding to one of a plurality of unique identification codes stored in an electronic database, where each of the printed identification markings has at least: a first portion printed with a first ink to produce a first visual effect (e.g., the appearance of a first color); and a second portion printed with a second ink that produces a second visual effect (e.g., the appearance of a second color) different than the first visual effect.

In yet another aspect, a computer-based method includes providing a plurality of substantially similar documents, generating a series of unique identification codes and printing an identification marking that corresponds to one of the identification codes for each of the documents. Each of the printed identification markings has at least: a first portion printed with a first ink to produce a first visual effect; and a second portion printed with a second ink that produces a second visual effect different than the first visual effect.

In still another aspect, a computer network includes a computerized security printing arrangement with a computer processing unit, a memory storage device coupled to the computer processing unit and a printer coupled to the computer processing unit and the memory storage device. The computer processing unit is adapted to generate a series of unique identification codes and store the series in a database in the memory storage device. The computer processing unit processing unit instructs the printer to print identification markings onto each of a plurality of substantially similar documents. Each identification marking corresponds to an associated one of the generated identification codes. Moreover, each of the printed identification markings has: a first portion printed with a first ink to produce a first visual effect; and a second portion printed with a second ink that produces a second visual effect different than the first visual effect.

In some implementations, the printer is adapted to apply two of more colors of ink to create the identification markings. The computer processing unit instructs the printer to print each identification marking such that the first portions and the second portions are different colors.

According to certain embodiments, the computer network further includes one or more computer terminals remotely-located relative to the computerized security printing arrangement, and coupled via a communications channel to the memory storage device of the computerized security printing arrangement.

In yet another aspect, a computer storage medium is encoded with a computer program that includes instructions that when executed by data processing apparatus cause the data processing apparatus to perform operations including: generating a series of unique identification codes for a plurality of documents; printing each unique identifier onto one of a plurality of documents using two or more colors; providing, on each printed identifier, a transition area at an area where a first of the two or more colors gradually blends into a second of the two or more colors.

In some implementations, one or more of the following advantages are present.

For example, reproducing variable information on documents having sections with different colors or the like is difficult to reproduce. As such, the techniques disclosed herein may deter or at least make it very difficult for a would-be counterfeiter to make counterfeit documents.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flowchart of a method of producing unique markings on multiple documents in a manner that will facilitate authentication of the documents.

FIG. 2 shows exemplary documents produced according to the method of FIG. 1.

FIG. 3 is a block diagram showing an exemplary system for producing and tracking documents made according to the method of FIG. 1.

FIG. 4 is a schematic representation showing a marking being applied to a document in the method of FIG. 1.

FIGS. 5-9 show various styles of markings that may be applied in the method of FIG. 1.

FIG. 10 shows a transition area between different portions of a marking that may be applied in the method of FIG. 1.

### DETAILED DESCRIPTION

This disclosure relates to document authentication and, more particularly, relates to systems and techniques to facilitate document authentication and tracking.

The systems and techniques disclosed herein can be applied to any type of documents for which authentication or tracking is desirable. Examples include, without limitation, identification cards, currency, credit cards, stored value cards, stock certificates, vital records, certificates of origin, labels, tapes, gift certificates, checks, passports, titles (e.g., automobile, land, etc.), coupons, various forms of commercial paper and the like.

In a typical implementation, applying a unique, prismatic identification marking to multiple otherwise similar documents can help a recipient of the document easily confirm its authenticity. In particular, each unique marking has at least two different portions that produce different visual effects, for example, each marking may have an upper portion that is a first color and a lower portion that is a second color different than the first. Such markings may be generally referred to as prismatic markings.

The technique of applying a unique, prismatic identification marking to multiple documents, particularly to a large number of such documents, is difficult to copy. As such, fraudulent duplication of this technique may be deterred.

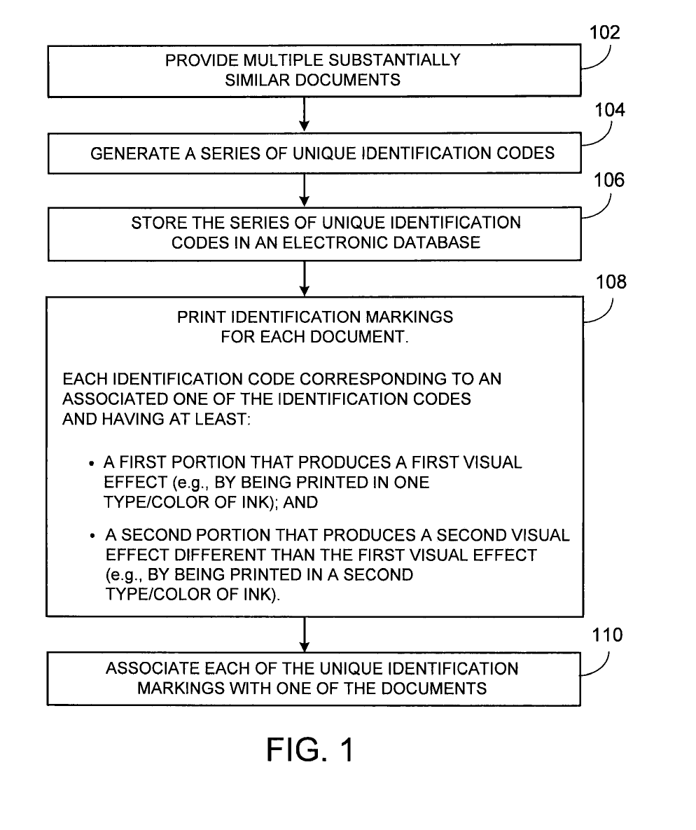

FIG. 1 is a flowchart showing a computer-based method of implementing the foregoing concepts. The method is considered to be computer-based because, in various implementations, one or more of the steps identified can be performed by a computer.

The illustrated method includes providing 102 multiple substantially similar documents. These documents can be, for example, without limitation, identification cards, currency, credit cards, stored value cards, stock certificates, vital records, certificates of origin, labels, tapes, gift certificates, checks, passports, titles (e.g., automobile, land, etc.), coupons, various forms of commercial paper and the like.

Typically, each document provided is at least substantially identical to the other documents provided. For example, each document provided can be a United States five dollar bill that is in production—before a serial number has been affixed to it. As another example, each document provided can be a gift certificate that is in production with blank spaces provided for a gift amount to be provided at a later time.

In other instances, there may be minor differences among the documents, however, their overall appearance still is substantially similar to one another. For example, a group of otherwise similarly appearing-gift certificates may be provided that identify different value designations thereon. In this example, although different value designations (e.g., $25, $50, $100) are printed on the gift certificates, as long as the gift certificates are otherwise similar in appearance, the gift certificates would be considered substantially similar to one another.

The illustrated method further includes generating 104 a series of unique identification codes. This typically would be done automatically by a computer processing unit. The identification codes may be logically-related to one another (e.g., sequential or otherwise related by a logical function) or random (e.g., generated by an electronic random number generator).

The unique identification codes typically are stored 106 in an electronic database. Moreover, in a typical implementation, the method includes creating a logical association in the electronic database between each stored identification code and the documents upon which corresponding identification markings are to be printed or affixed. If, for example, a corresponding identification marking is to be printed or affixed to gift certificates having a particular value designations (e.g., $50), then the identification code may be stored in the electronic database along with indications that the corresponding marking is associated with a $50 gift card.

The illustrated method further includes printing 108 identification markings for each document. The identification markings can be printed directly on each document or, alternatively, can be printed on labels for subsequent securing (by the use of adhesives or other methods) to each document.

In a typical implementation, each printed identification marking corresponds to one of the generated identification codes. In some instances, the applied identification markings are exact replicas of the generated identification codes. In other instances, the applied identification markings may be derived from the generated identification codes.

The identification markings are unique relative to one another and can include any type of characters (or combinations of characters) such as: alphabetical characters, numerical characters, symbols, barcodes, images, bitmaps or the like.

Each applied marking is formed so that it has at least a first portion that produces a first visual effect (e.g., a first color) and a second portion that produces a second visual effect (e.g., a second color) that is different than the first visual effect. The different visual effects can be produced by using different colored ink, by using different types of ink (e.g., a fluorescent ink and a non-fluorescent ink), by creating different visual patterns within the outlines of the markings' characters, etc.

If, for example, a marking has a series of alphanumeric characters, an upper portion of each character may be red and a lower portion of each character may be black. As another example, each marking may be printed using fluorescent ink such that, upon exposure to an ultraviolet light source, an upper portion of each character glows red and/or a lower portion of each characters glows green. In some instances, each marking is applied so that at least a portion of the marking is substantially not visible under normal ambient lighting conditions, but instead, requires exposure to special lighting conditions (e.g., ultraviolet lighting conditions) to reveal a portion of (or the entirety of) its characters.

Each applied marking can include more than two different portions, where adjacent portions have different appearances (e.g., colors) from one another. For example, each applied marking can have three, four or more different portions, each having a different visual appearance (e.g., a red portion next to a black portion next to a blue portion). Alternatively, each applied marking can have multiple portions having alternating appearances (e.g., a red portion next to a black portion next to another red portion).

The different portions of the characters can be divided horizontally, vertically, diagonally or in any other manner through the markings.

The illustrated method includes the optional step of associating 110 each of the unique identification markings with one of the documents. This step can include, for example, securing adhesive labels with the markings printed thereon to corresponding documents, and is typically implemented only if the identification markings are not first printed onto the documents themselves. If, for example, the identification markings are printed on an adhesive label, then the identification markings become “associated” with their corresponding documents when they are adhered to the corresponding documents.

The combination of providing unique identification markings on each document, where each unique marking has at least two different portions that produce different visual effects (e.g., by color, pattern, fluorescing, etc.) is a simple way to enhance a recipient's ability to authenticate a document while also uniquely identifying each document.

FIG. 1 shows an exemplary set of documents 202a, 202b, 202c . . . 202n that can be produced using the method of FIG. 1.

In the illustrated example, each document 202a, 202b, 202c has a background with a “void” pantograph printed across its surface and includes a unique identification marking 204a, 204b, 204c . . . 204n printed (or affixed) in a lower left hand corner thereof. The “void” pantograph does not readily photocopy. As shown, each identification marking includes a series of alphanumeric characters. In the illustrated embodiment, the series of markings increments sequentially (e.g., ABCD1234, ABCD1235, ABCD1236 . . . ABCD1239) from document to document. In various implementations, the markings in any particular series can relate to one another according to any logical relationship or can be random relative to one another.

As indicated in the magnified view of identification marking 204a, which is typical of all of the identification markings 204a, 204b, 204c . . . 204n, the upper portion of each character is red and the lower portion of each character is black. The horizontal line shown in the magnified view of identification marking 204a is provided only to identify the boundary between the upper and lower portions of the marking; typically it would not visible on the document or in the marking 204a itself.

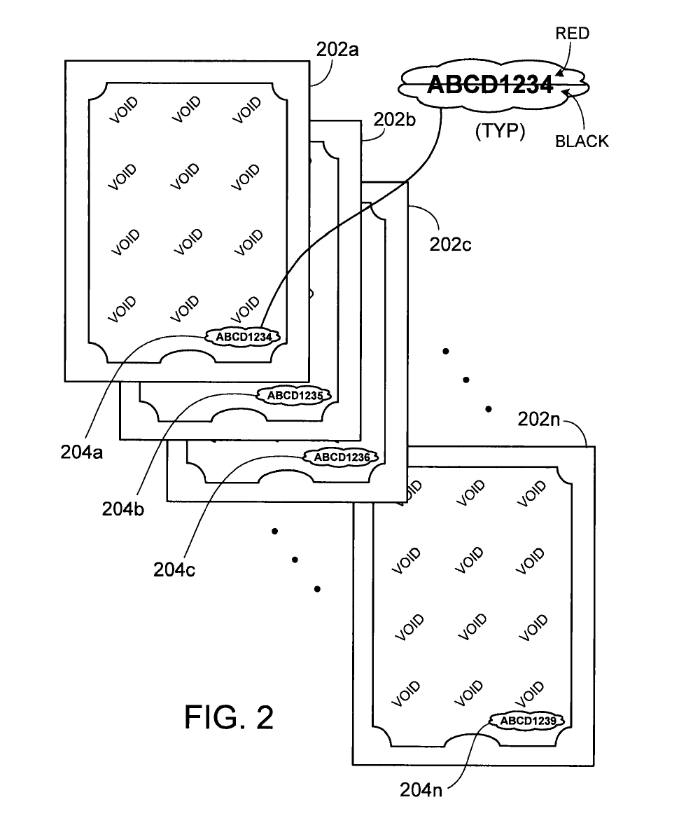

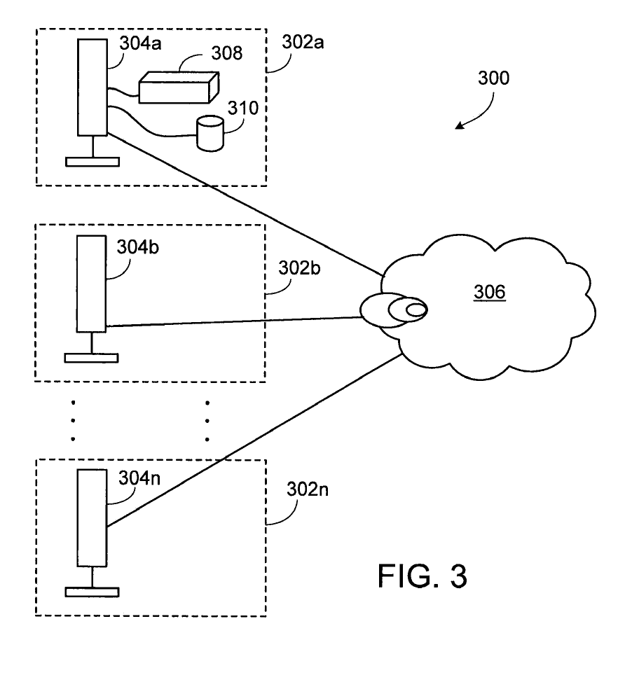

FIG. 3 is a block diagram of an exemplary computer system 300 that can be used to create and track a set of documents such as those shown in FIG. 2.

The illustrated system includes computer components at a variety of physical locations 302a, 302b . . . 302n. Location 302a is a production facility 302a for printing (or otherwise affixing) identification markings to documents. The other locations 302b and 302n are remotely located relative to the production facility 302a and enable users at those remote locations to access information about the documents that have been marked with identification markings at the production facility 302a.

Each location has a user terminal 304a, 304b . . . 304n that enable a user to interact with the computer system 300, access various information and, in some instances discussed below, control various system processes. The user terminals 304a, 304b . . . 304n are coupled to one another over a communications network 306 (e.g., the Internet). In a typical implementation, each user terminal includes at least a graphical user interface and one or more input devices (e.g., a keyboard, a computer mouse or the like) that the user can use to interact with the system 300.

In the illustrated embodiment, the production facility 302a includes user terminal 304a as well as a production printer 308 and computer storage medium 310, housing an electronic database, coupled to the user terminal 304a.

In a typical implementation, the printer 308 in the production facility 302a is a commercial ink jet printer adapted to print one or more identification markings on the documents themselves or on labels that are later adhered to the documents. The printer 308 typically operates pursuant to control data entered by a user at the user terminal 304a and prints identification markings that correspond to identification codes stored in the electronic database.

The printer 308 typically includes software and/or hardware provisions for positioning and moving the documents (or document labels) through the printer. As an example, the printer 308 includes an industrial document feeding base. The printer 308 also typically include multiple pens or multiple cartridges, each of which is adapted to deliver a particular type of ink or marking.

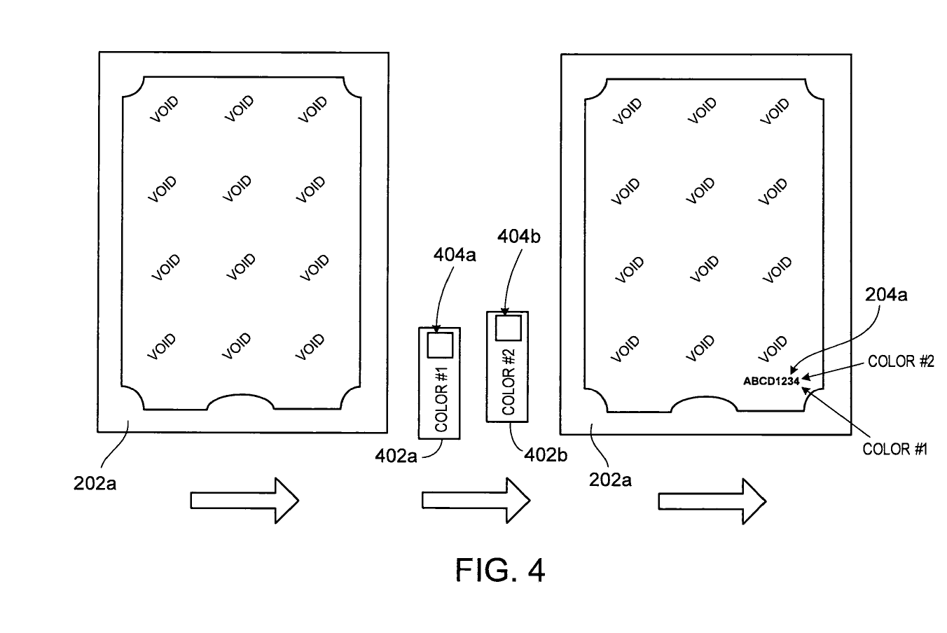

FIG. 4 shows an exemplary arrangement of printer cartridges 402a, 402b in a printer (e.g., printer 308) and a document 202a passing through the printer. The arrows represent the document's 202a direction of movement relative to the printer cartridges 402a, 402b. The image on the left part of the figure shows the document 202a before it has passed by the printer cartridges. As such, it does not include an identification marking. The image on the right part of the figure, however, shows the document 202a after it has passed by the printer cartridges. As such, it does include an identification marking 202a with an upper portion in one color (e.g., non-fluorescent red) and a lower portion in a second color (e.g., fluorescent yellow).

In this example, printer cartridge 402a is adapted to deliver fluorescent yellow ink, whereas printer cartridges 402b is adapted to deliver non-fluorescent red ink. Each cartridge 402a, 402b has an associated print area 404a, 404b (i.e., an area that the cartridges can deliver ink to). In the illustrated example, the cartridges 402a, 402b and their respective print areas 402a, 402b are offset relative to one another (i.e., they are not aligned along the axis that the document 202a is moving) so that the fluorescent yellow ink cartridge 402a prints a first portion (i.e., a lower portion) of the identification marking 204a as the document 202a passes by, while the non-fluorescent red ink cartridge 402b prints a second portion (i.e., the lower portion) of the identification marking 204a as the document passes by. In the illustrated example the first and second portions of the identification marking 204a combine to form alphanumeric code “ABCD1234.”

In one exemplary implementation of a printer, sample prints were produced by adapting Inc.jet, Inc.'s Jet.engine GUI software, version 1.50.3 (Build: 209) in combination with Inc.jet Jet.engine print controller and pens utilizing HP 45A cartridges to produce markings such as those disclosed herein.

In a typical implementation, after the identification marking “ABCD1234” is applied to the document 202a, a subsequent document (e.g., document 204b from FIG. 2) is fed into the printer past the printer cartridges 402a, 402b. A subsequent identification marking different than “ABCD1234” is applied to the subsequent document. The subsequent identification marking can be logically-related to the “ABCD1234” marking (e.g., “ABCD1234”) or not logically related to the “ABCD1234” marking (e.g., “%*$” or “798”).

Referring again to FIG. 3, the computer components in the production facility 302a are adapted to store the identification markings that are applied to various documents in an electronic database in the computer storage medium 310. In some implementations, the electronic database also stores various information related to each stored identification markings. For example, in some implementations, the electronic database indicates what type of document each identification marking has been applied to, physical characteristics of each identification marking (e.g., upper portion in fluorescent yellow, bottom portion is non-fluorescent red), characteristics of the document that each identification marking was applied to (e.g., a value amount for a gift card) and/or other features that are useful to help a user confirm that a particular document is authentic. In a typical implementation, the various information stored in the electronic database may be accessible at any of the user terminals 304a, 304b . . . 304n.

In a typical implementation, software enables a user at terminal 304a, for example, to specify how each pen, color, or cartridge in a printer should print a set of identification markings. To do this, the user may be presented with a calibration chart that could include a series of horizontal or vertical lines with different thicknesses and values. The chart data would allow and assist the user to effectively position and align individual pens, colors, and/or cartridges laterally or longitudinally and/or to optionally set a dot overlap at the transition between different color portions manually and with software offsets.

In a typical implementation, the variable information (e.g., identification markings) is first be designed by specifying size, shape, barcode type, font, rotation, etc. This information may be entered into terminal 304a, for example. In some implementations, an algorithm causes the variable information to dynamically change once one piece of variable information has been printed. This dynamic changing can occur with the assistance of an electronic counter or by referencing an electronic database storing the variable information.

Once the variable information algorithm and design has been completed the printers, cartridges, etc. in printer 308 are positioned electronically so that the multiple color splits will happen in the desired locations. This can be done, for example, in at least two types of orientations: splitting the entire variable information image across its full length or splitting the variable information image into predefined segments with the color transition occurring within an identification marking (e.g., within one of the characters in an identification marking). The color splits typically result from positioning the designed form across the boundaries of the multiple pens, colors, or cartridges.

In typical instances, the software used to program a printer allows for separation, overlap of color, and/or pen stitching.

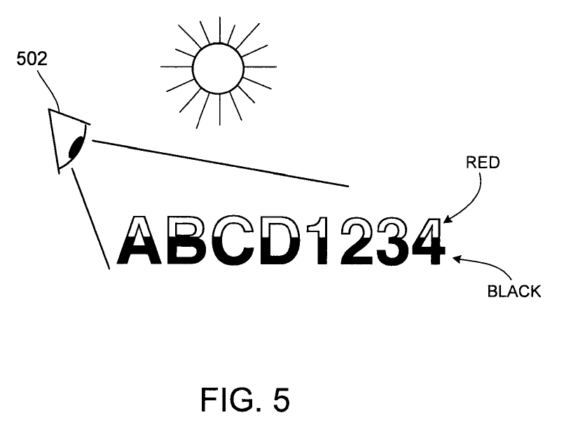

FIGS. 5, 6A, 6B, 7A, 7B, 8 and 9 show various exemplary styles that the variable identification markings can have.

FIG. 5, for example, shows an overt identification marking, which can be authenticated using the bare eye 502 in normal ambient light conditions (i.e., without the use of a special reader or security device). In the illustrated example, the information in the identification marking is printed using multiple visible colors. More particularly, the upper portion of the marking is red and the lower portion of the marking is black.

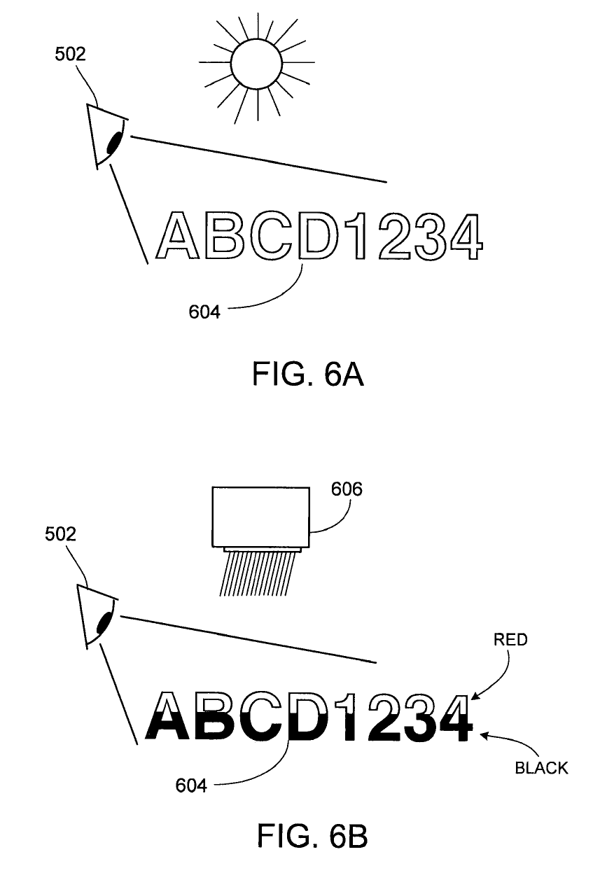

FIGS. 6A and 6B show an example of a covert identification marking 604.

In covert identification markings, the variable information requires the use of some device or reader 606 for viewing view. In the illustrated example, the lower portion of the identification marking 604 is printed in blue ultraviolet ink and the upper portion of the identification marking 604 is printed in red ultraviolet ink. The ultraviolet inks are designed so that they appear substantially invisible under normal ambient lighting conditions, but fluoresce, thereby making them visible, when exposed to ultraviolet light.

FIG. 6A shows the identification marking 604 under normal ambient lighting conditions. In the illustration, the outline of the characters that make up the identification marking is shown merely to show the pattern of ink on the document. In a typical implementation, however, this ink would be substantially not visible under normal ambient lighting conditions. Nor would the outline be visible under normal ambient lighting conditions.

FIG. 6B shows the same covert identification marking 604 exposed to an ultraviolet light source 606.

In FIG. 6B, the ultraviolet light source 606 renders the identification marking 604 substantially visible to the human eye 502. In the illustrated example, under the ultraviolet light source, the upper portion of the identification marking 604 appears red and the lower portion of the identification marking appears blue.

In other implementations, other specialty inks (e.g., those that are responsive to infrared light sources or light sources at other wavelengths) may be used to print one or more portions of an identification marking.

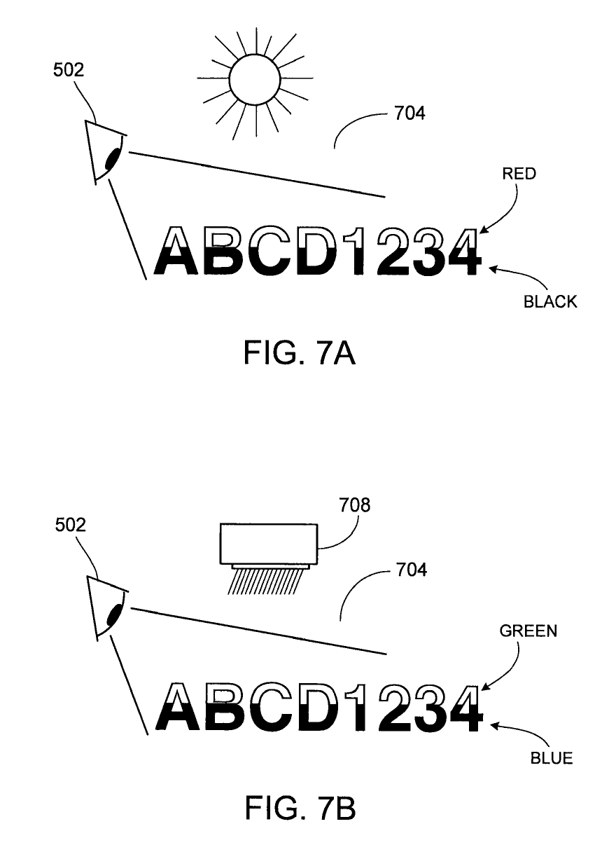

FIGS. 7A and 7B shows an example of an identification marking 704 whose appearance changes depending on ambient lighting conditions.

FIG. 7A indicates that the exemplary identification marking 704 appears to be red and black under normal ambient lighting conditions. The ink that forms the illustrated marking 704 includes one or more additives that fluoresce under special light sources (e.g., when exposed to an ultraviolet or infrared light sources).

FIG. 7B indicates that when exposed to an ultraviolet light source 708, the red portion of the identification marking 704 fluoresces green and the black portion of the identification marking 704 fluoresces red.

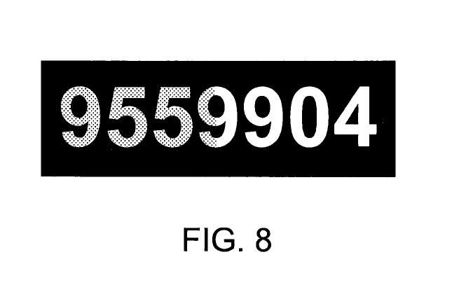

FIG. 8 shows an example of an identification marking in which the first portion of the printed identification marking is a left portion of the identification marking and the second portion of the printed identification marking is a right portion of the identification marking. In the illustrated marking, which consists of “9559904,” “955” is a first color, “904” is a second color that is different than the first and the “9” in the middle of the marking is both colors, with a transition between the two.

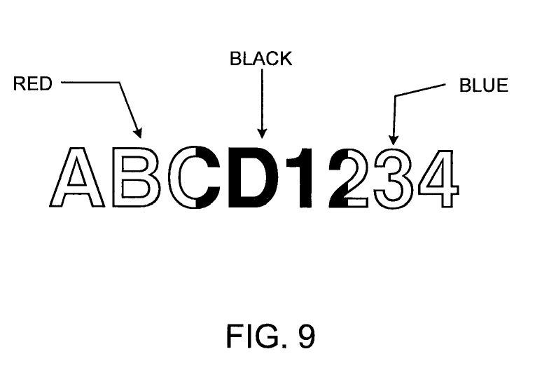

Similarly, FIG. 9 shows an example of an identification marking that has three vertical portions, a left portion (in red), a middle portion (in black) and a right portion (in blue).

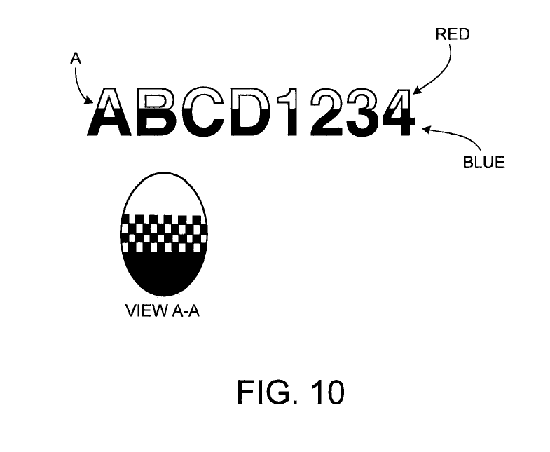

FIG. 10 shows another example of an identification marking that includes a feature that may further enhance a viewer's ability to authenticate a document and to increase the difficulty with which the document could be fraudulently duplicated.

The illustrated marking includes an alphanumeric code: “ABCD1234” that has an upper red portion, a lower blue portion and a transition area between the upper and lower portions. As shown in magnified view A-A, the transition area between the upper and lower portions includes a checkered pattern of alternating colors (e.g., some red and some blue). In various implementations, other alternating patterns may be included as well.

In a typical implementation, the alternating pattern of colors (or matrix of alternating colors) is not visible without the aid of magnification.

In some implementations, a user can specify dot overlap, as shown in FIG. 10, or other portion interface characteristics if desired, at user terminal 304a in FIG. 3. Typically, the dot overlap characteristics are set in such a way that there is a slight overlap creating a color transition area with a pattern of alternating ink types when colors are used when there is not a dominant color preventing visual overlap determination. The overlap is set to not cause deformation of the printed characters.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Additionally, in some implementations, more than one unique, prismatic marking may be applied to each document. These multiple markings may be next to one another or separated from one another. They also may be on opposite sides of the document.

Additionally, the different portions of the markings can produce different visual effects by having different portions of the characters filled in with different visual patterns (e.g., polka dots, vertical lines, horizontal lines, etc.). Similarly, in some implementations, one or more portions of a marking may be colored and other portions may be patterned.

The unique identification codes can be, but are not limited to, alphanumeric, alphabetical, numeric codes.

Thus, particular embodiments of the subject matter have been described. Other embodiments are within the scope of the following claims.

What is claimed is:

1. A computer-based method comprising:
providing a plurality of substantially similar documents;
generating a series of unique identification codes;
printing an identification marking that corresponds to one of the identification codes for each of the documents,
wherein each of the printed identification markings comprises at least:
a first portion printed with a first ink to produce a first visual effect; and
a second portion printed with a second ink that produces a second visual effect different than the first visual effect.

2. The computer-based method of claim 1 wherein the series of unique identification codes is generated by a computer processor and wherein the identification markings are printed by an electronic printer coupled to the computer processor.

3. The computer-based method of claim 1 further comprising:
associating each of the unique identification markings with one of the documents.

4. The computer-based method of claim 1 wherein the first portion of each printed identification marking is an upper portion the identification marking and wherein the second portion of each printed identification marking is a lower portion of the identification marking.

4. The computer-based method of claim 1 wherein the first portion of each printed identification marking is a left portion of the identification marking and wherein the second portion of each printed identification marking is a right portion of the identification marking.

5. The computer-based method of claim 4 wherein the printed identification marking comprises a plurality of discrete characters,
wherein the first portion of each identification code transitions into the second portion of each identification code within one of the characters.

6. The computer-based method of claim 1 further comprising:
storing each unique identification code in an electronic database.

7. The computer-based method of claim 5 further comprising:
creating a logical association in the electronic database between each stored identification code and one of the documents upon which a corresponding one of the identification markings is printed or affixed.

8. The computer-based method of claim 1 wherein the first portion of each identification marking or the second portion of each identification marking is substantially invisible to the human eye absent exposure to an environmental condition.

9. The computer-based method of claim 8 wherein the first portion of each identification marking and the second portion of each identification marking is substantially invisible to the human eye absent exposure to the environmental condition.

10. The computer-based method of claim 8 wherein the environmental condition is selected from the group comprising: an ultra-violet or infrared light source, a source of heat and a chemical.

11. The computer-based method of claim 8 wherein each identification marking is printed such that, upon exposure to the environmental condition, the first portion of the identification marking and the second portion are different colors.

12. The computer-based method of claim 8 wherein each identification marking is printed using fluorescent ink such that, upon exposure to an ultraviolet light source as the environmental condition, the first portion of each identification marking or the second portion of each identification marking glows.

13. The computer-based method of claim 1 wherein the first ink and the second ink are different colors.

14. The computer-based method of claim 1 wherein all of the substantially similar documents are one of the following: identification cards, currency, credit cards, stored value cards, stock certificates, vital records, certificates of origin, labels, tapes, gift certificates, checks, passports, titles, coupons, or forms of commercial paper.

15. The computer-based method of claim 1 wherein each identification marking is printed on an associated one of a plurality of adhesive labels, the method further comprising:
securing one adhesive label including a printed identification marking to each of the documents.

16. The computer-based method of claim 1 wherein each identification marking comprises an alphabetic code, a numeric code, an alphanumeric code, a symbolic code, a barcode, an image code or a bitmap code.

17. The computer-based method of claim 1 wherein the unique identification codes are logically-related to one another.

18. The computer-based method of claim 1 wherein the unique identification codes are random relative to one another.

19. The computer-based method of claim 1 wherein the identification marking comprises a transition area between the first portion of the marking and the second portion of the marking,
wherein the transition area comprises a gradual blending of one color into another color.

20. The computer-based method of claim 19 wherein the transition area comprises printed dots of the first ink interspersed among printed dots of the second ink.

21. The computer-based method of claim 20 wherein the printed dots are only visible under magnification.

22. A system for facilitating document tracking and authentication, the system comprising:
a plurality of substantially identical documents;
a unique identification marking on each document, each identification marking corresponding to one of a plurality of unique identification codes stored in an electronic database;
wherein each of the printed identification markings comprises at least:
a first portion printed with a first ink to produce a first visual effect; and
a second portion printed with a second ink that produces a second visual effect different than the first visual effect.

23. A computer-based method comprising:
providing a plurality of substantially similar documents;
generating a series of unique identification codes;
printing an identification marking that corresponds to one of the identification codes for each of the documents,
wherein each of the printed identification markings comprises at least:
a first portion printed with a first ink to produce a first visual effect; and
a second portion printed with a second ink that produces a second visual effect different than the first visual effect.

24. A computer network comprising:
a computerized security printing arrangement comprising:
a computer processing unit;
a memory storage device coupled to the computer processing unit; and
a printer coupled to the computer processing unit and the memory storage device,
wherein the computer processing unit is adapted to generate a series of unique identification codes and store the series in a database in the memory storage device;
wherein the computer processing unit processing unit instructs the printer to print identification markings onto each of a plurality of substantially similar documents,
wherein each identification marking corresponds to an associated one of the generated identification codes;
wherein each of the printed identification markings comprises:
a first portion printed with a first ink to produce a first visual effect; and
a second portion printed with a second ink that produces a second visual effect different than the first visual effect.

25. The computer network of claim 24 wherein the printer is adapted to apply two of more colors of ink to create the identification markings, and
wherein the computer processing unit instructs the printer to print each identification marking such that the first portions and the second portions are different colors.

26. The computer network of claim 24 further comprising:
one or more computer terminals remotely-located relative to the computerized security printing arrangement, and coupled via a communications channel to the memory storage device of the computerized security printing arrangement.

27. A computer storage medium encoded with a computer program, the computer program comprising instructions that when executed by data processing apparatus cause the data processing apparatus to perform operations comprising:
generating a series of unique identification codes for a plurality of documents;
printing each unique identifier onto one of the plurality of documents using two or more colors;
providing, on each printed identifier, a transition area at an area where a first of the two or more colors gradually blends into a second of the two or more colors.
